(19) United States
(12) Patent Application Publication
(10) Pub. No.: US 2025/0139514 A1
(43) Pub. Date: May 1, 2025

(54) Methods and Systems for Bilateral Simultaneous Training of User and Device for Soft Goods Having Gestural Input

(71) Applicant: Google LLC, Mountain View, CA (US)

(72) Inventors: Lauren Marie Bedal, San Francisco, CA (US); Lawrence Au, Sunnyvale, CA (US); Mei Lu, Los Altos, CA (US); Nicholas Gillian, Palo Alto, CA (US); Leonardo Giusti, San Francisco, CA (US)

(21) Appl. No.: 18/833,523

(22) PCT Filed: Jan. 26, 2022
(86) PCT No.: PCT/US2022/013788

§ 371 Date: Jul. 26, 2024

(51) Int. Cl. G06N 20/00; G06F 3/044; G06F 3/04883; G06N 3/044; G06N 3/0464; G06N 3/08

(52) U.S. Cl. CPC G06N 20/00; G06F 3/044; G06F 3/04883; G06N 3/044; G06N 3/0464; G06N 3/08

(57) ABSTRACT

The present disclosure provides computer-implemented methods, systems, and devices for efficient bilateral training of users and devices with touch input systems. An interactive object generates, based on a first output of the machine-learned model in response to sensor data associated with a first touch input, first inference data indicating a negative inference corresponding to a first gesture. The interactive object generates, based on an output of the machine-learned model in response to sensor data associated with a second touch input, second inference data indicating a positive inference corresponding to the first gesture. The interactive object, in response to generating the positive inference subsequent to the negative inference, generates training data as a positive training example of the first gesture. The interactive object trains the machine-learned model based at least in part on the training data.

### FIELD

The present disclosure relates generally to training a machine-learned model to more accurately infer gestures based on user input. More particularly, the present disclosure relates to using a machine-learned model that is trained with sensor data associated with failed attempts to input gestures

### BACKGROUND

An interactive object can include sensors (e.g., touch-based sensors) that are incorporated into the interactive object and configured to detect user input. The interactive object can process the user input to generate sensor data that is usable as input to a machine-learned model. The machine-learned model can generate inferences to determine a specific gesture associated with the input and initiate functionality associated with the determined gesture(s). The functionality can be implemented locally at the interactive object or at various computing devices that are communicatively coupled to the interactive object. However, the user experience can be degraded if the machine-learned model is often unable to generate an inference that corresponds to gesture that was intended by the user.

### SUMMARY

Aspects and advantages of embodiments of the present disclosure will be set forth in part in the following description, or may be learned from the description, or may be learned through practice of the embodiments.

One example embodiment includes an interactive object. The interactive object includes a touch sensor configured to generate sensor data in response to touch inputs and one or more computing devices. The one or more computing devices are configured to input, to a machine-learned model configured to generate gesture inferences based on touch inputs to the touch sensor, sensor data associated with a first touch input to the touch sensor. The one or more computing devices are configured to generate, based on a first output of the machine-learned model in response to the sensor data associated with the first touch input, first inference data indicating a negative inference corresponding to a first gesture. The one or more computing devices are configured to store the sensor data associated with the first touch input. The one or more computing devices are configured to input, to the machine-learned model, sensor data associated with a second touch input to the touch sensor, the second touch input being received by the touch sensor within a predetermined period after the first touch input. The one or more computing devices are configured to generate, based on an output of the machine-learned model in response to the sensor data associated with the second touch input, second inference data indicating a positive inference corresponding to the first gesture. The one or more computing devices are configured to, in response to generating the positive inference subsequent to the negative inference, generate training data that includes at least a portion of the sensor data associated with the first touch input and one or more annotations that indicate the first touch input as a positive training example of the first gesture. The one or more computing devices are configured to train the machine-learned model based at least in part on the training data.

Another example embodiment includes a computing device. The computing device comprises an input sensor configured to generate sensor data in response to a user gesture input and one or more processors. The one or more processors are configured to input, to a machine-learned model configured to generate gesture inferences based on user gesture inputs to the input sensor, sensor data associated with a first user input to the input sensor. The one or more processors are configured to generate, based on a first output of the machine-learned model in response to the sensor data associated with the first user input, first inference data indicating a negative inference corresponding to a first gesture. The one or more processors are configured to store the sensor data associated with the first user input. The one or more processors are configured to input, to the machine-learned model, sensor data associated with a second user input to the input sensor, the second user input being received by the input sensor within a predetermined period after the first user input. The one or more processors are configured to generate, based on an output of the machine-learned model in response to the sensor data associated with the second user input, second inference data indicating a positive inference corresponding to the first gesture. The one or more processors are configured to, in response to generating the positive inference subsequent to the negative inference, generate training data that includes at least a portion of the sensor data associated with the first user input and one or more annotations that indicate the first user input as a positive training example of the first gesture.

The one or more processors are configured to train the machine-learned model based at least in part on the training data.

Another example embodiment comprises a computer-implemented method. The method can be performed by a computing system comprising one or more computing devices, The method comprises inputting, to a machine-learned model configured to generate gesture inferences based on touch inputs to a touch sensor, sensor data associated with a first touch input to the touch sensor. The method further comprises generating, based on a first output of the machine-learned model in response to the sensor data associated with the first touch input, first inference data indicating a negative inference corresponding to a first gesture. The method further comprises storing the sensor data associated with the first touch input. The method further comprises inputting, to the machine-learned model, sensor data associated with a second touch input to the touch sensor, the second touch input being received by the touch sensor within a predetermined period after the first touch input. The method further comprises generating, based on an output of the machine-learned model in response to the sensor data associated with the second touch input, second inference data indicating a positive inference corresponding to the first gesture. The method further comprises, in response to generating the positive inference subsequent to the negative inference, generating training data that includes at least a portion of the sensor data associated with the first touch input and one or more annotations that indicate the first touch input as a positive training example of the first gesture.

Other example aspects of the present disclosure are directed to systems, apparatus, computer program products (such as tangible, non-transitory computer-readable media but also such as software which is downloadable over a communications network without necessarily being stored in non-transitory form), user interfaces, memory devices, and electronic devices for bilateral simultaneous training of user and device.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

A detailed discussion of embodiments directed to one of ordinary skill in the art are set forth in the specification, which refers to the appended figures, in which:

FIG. 1 is an illustration of an example environment 100 in which an interactive object including a touch sensor can be implemented.

FIG. 2 illustrates a block diagram of an example computing environment that includes an interactive object having a touch sensor in accordance with example embodiments of the present disclosure.

FIG. 3 illustrates an example of a sensor system, such as can be integrated with an interactive object in accordance with one or more implementations.

FIG. 4 illustrates an example system for updating a machine-learned model based on failed attempts to input a gesture in accordance with example embodiments of the present disclosure.

FIGS. 5A-5C illustrate an example process for evaluating touch inputs in accordance with example embodiments of the present disclosure.

FIG. 6 illustrates a block diagram of an example failed attempt sensor data storage 234 in accordance with example embodiments of the present disclosure.

FIG. 7 illustrates a flow chart depicting an example process for enabling an interactive object to receive touch inputs from a user and accurately determine associated gestures in accordance with example embodiments of the present disclosure.

FIG. 8 illustrates an example computing environment including a server system and one or more user computing devices in accordance with example embodiments of the present disclosure.

FIG. 9 is a flowchart depicting an example method of identifying a gesture based on touch input in accordance with example embodiments of the present disclosure.

FIG. 10 is a flowchart depicting an example method of analyzing sensor data associated with failed attempts in accordance with example embodiments of the present disclosure.

FIG. 11 is a flowchart depicting an example method of training a machine-learned model that is configured to identify gestures based on sensor data generated in response to touch input from a user.

FIG. 12 depicts a block diagram of an example classification model 1200 according to example embodiments of the present disclosure.

FIG. 13 is a flowchart depicting an example process of updating a machine-learned model based on the sensor data for failed attempts to input a gesture in accordance with example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed towards an object (e.g., a deformable or “soft” object) with improved detection of gestural inputs using a machine-learned model that is trained with sensor data associated with failed attempts to input gestures. For example, a sensor system included in an interactive object may generate sensor data in response to a first user input (e.g., a first touch input), provide the sensor data to the machine-learned model, and receive an output from the machine-learned model indicating that the first user input is not recognized as a particular gesture. Subsequently, the sensor system may generate sensor data in response to a second user input (e.g., a second touch input), provide the sensor data to the machine-learned model, and receive an output from the machine-learned model indicating that the second touch input is recognized as a particular gesture. In response to the positive inference of the particular gesture relative to the second input following the negative inference of the particular gesture relative to the first input, the sensor system can infer that the first input from the user was an attempt by the user to perform the particular gesture that was previously not recognized by the model. The sensor system can then generate training data for the model by annotating the sensor data generated in response to the first user input to indicate that it is a positive example of the particular gesture. The model can be re-trained using the training data generated by annotating the sensor data. In such fashion, attempts by a user to perform a gesture which were originally considered as “failed”, may ultimately be labeled as positive training examples for the gesture, based on an inference that the user has responded to the “failure” by repeating the same gesture. After re-training the model based on the labeled data, the model may be able to more accurately classify or detect the gesture performed by the user. Stated differently, the model can be personalized to better account for the specific gesture action performed by the specific user. In some examples, the personalization can allow a user to use gestures that reflect their particular abilities. In other examples, a user can, over time, customize the standard gestures used by the sensor system to accommodate the preferences of a user. In this way, a user's particular style, flair, or eccentricities can be implemented into the gestures detected by the sensor system.

More particularly, consider, for example, that a user may attempt to perform a gesture by providing touch input to a touch sensor. For some attempts, the intended gesture may not be recognized by the sensor system despite the user actually attempting to perform the intended gesture. In response to the sensor system not recognizing the gesture, a common response from the user is to attempt to perform the gesture again. The user may continue to attempt to perform the gesture until the sensor system recognizes the intended gesture. Thus, it can be appreciated that a series of failed attempts followed by a successful attempt may actually all be attempts to enter the same gesture. Accordingly, embodiments in accordance with the present disclosure are directed to the identification of sensor data associated with failed attempts to input gestures and the use of such sensor data to train the sensor system to better recognize touch inputs as corresponding to particular input gestures.

By way of example, the sensor system can identify one or more failed attempts followed by a successful attempt to input a particular gesture. When the particular gesture is successfully recognized, the sensor system can annotate the sensor data corresponding to the one or more failed attempts by generating labels that indicate the sensor data corresponds to the particular gesture recognized in response to the successful attempt. This labelled sensor data can be used to improve the ability of the sensor system to recognize the particular gesture. For example, the sensor system can annotate the sensor data with a label or other information to indicate that the sensor data is a positive example of the gesture. The annotated sensor data can be used as training data to train the machine-learned model associated with the sensor system to detect the particular gesture.

Thus, a sensor system can annotate the sensor data for the one or more failed attempts as corresponding to the successfully entered gesture. The annotated sensor data can be stored as training data. The sensor system can train the machine-learned model with the training data. Training the machine-learned model using sensor data associated with failed attempts to enter a gesture can enable the machine-learned model to identify intended gestures from that particular user more accurately. Thus, a local machine-learned model installed on a device used by a specific user can, over time, become customized to recognize gestures from that specific user, improving the user experience for that user while not affecting the machine-learned models on any other device.

The ability to customize a machine-learned model as described herein may have particular benefits for certain users with reduced range of motion or physical control and who, therefore, may struggle to input or perform a gesture in a manner that corresponds to the input profile observed for the general public. Thus, aspects of the present disclosure increase accessibility for disabled users or other users with motion impairment by personalizing a model to recognize a user-specific input profile for one or more gestures, including based on gesture data that would otherwise be considered as “failed”. Further, in some implementations, the proposed techniques may be performed in a fully automated manner, such that a user is not required to give explicit tagging inputs or otherwise interact with an interface which may cause the user frustration by highlighting the user's failed attempts at performing the gesture.

In addition to providing benefits for users with reduced range of motion or physical control, the ability to customize a machine-learned model can also enable all users of whatever ability to customize the inputs associated with gestures based on each user's own preferences or idiosyncrasies. Thus, a user can, through the repeated input of preferred gestures, customize the model to recognize gesture inputs that reflect the user's own flair or style. These customizations can automatically, without direct input from the user, occur only at the local version of the machine-learned model and do not affect machine-learned models local to other interactive objects.

Consider an example of a user attempting to provide touch input for a particular gesture such as a pinch gesture, swipe gesture, brush gesture, etc. The touch gesture may be recognized by a touch sensor embedded in the sleeve of a jacket or other interactive textile or “soft” good. The user may make several attempts to provide touch input for the particular gesture before the machine-learned model correctly identifies the particular gesture. Once the particular gesture is correctly identified, a sensor system included in the jacket can identify one or more failed attempts to make the particular gesture that were received prior to the successful attempt. The sensor data received in the one or more failed attempts to make the particular gesture can be annotated with a label that indicates that the sensor data for the one or more failed attempts corresponds to the particular gesture that was successfully entered. Training data can be generated based on the annotated sensor data. The machine-learned model can be trained using the generated training data. Once the model has been trained using the generated training data, future attempts by the user to input the particular gesture are likely to be correctly identified by the machine-learned model. In this way, only the machine-learned model on the sensor system associated with the user is updated, and thus other users will not see a change in the way their sensor systems identify gestures.

In some examples, the sensor system can include a gesture evaluation system to identify gestures based on touch input by using sensor data generated by a touch sensor in response to the touch input as the input to a machine-learned model. The machine-learned model can output inference data based on the sensor data used as input. In some examples, the inference data can indicate whether the sensor data corresponds to a particular gesture. For example, the inference data can include a positive inference that the sensor data corresponds to the particular gesture. Alternatively, the inference data can include a negative inference. A negative inference can indicate that the sensor data does not correspond to the particular gesture. In some examples, a negative inference can indicate that the sensor data does not correspond to any gesture that the machine-learned model has been trained to recognize.

To determine whether the inference data includes a positive inference or a negative inference with respect to a first gesture, the gesture evaluation system can analyze the inference data. For example, the inference data can include data that classifies the touch input as indicating the first gesture. Thus, if the inference data indicates that the touch input corresponds to the first gesture, the inference data can be described as including a positive inference for the first gesture. The inference data can indicate the first gesture using one-hot encoding or another method of indicating a single gesture that corresponds to the sensor data. In another example, the inference data can include a list of one or more candidate gestures. In this example, the machine-learned model can output a confidence value associated with each candidate gesture. The confidence value can represent the degree to which the sensor data is associated with a particular candidate gesture, such that the higher the confidence value, the more likely the touch input was intended to be the candidate gesture. If the confidence value associated with the first gesture exceeds a first confidence value threshold, the gesture evaluation system can determine that the inference data includes a positive inference that the sensor data corresponds to a first gesture.

In some examples, the inference data can include data indicating that the received sensor data does not correspond to the first gesture. For example, the inference data can indicate non-performance of any gesture that the machine-learned model is trained to recognize. For example, the confidence value of all candidate gestures is below the first confidence value threshold. The inference data can include classification data indicating that the received input is non-gestural (e.g., does not correspond to any gesture for which the machine-learned model is trained). If so, the system can determine that the inference data includes a negative inference with respect to the first gesture. As discussed above, the inference data can include one or more candidate gestures, each with an associated confidence value. If no candidate gesture has a confidence value above the first confidence value threshold, the gesture evaluation system can determine that the inference data includes a negative inference with respect to the first gesture. In some examples, the gesture evaluation system can determine that the inference data includes a negative inference with respect to all gestures for which the machine-learned model is trained. The system can store sensor data for which a negative inference is generated. In some examples, the inference data itself can also be stored in a failed attempt sensor data storage. In some examples, the failed attempt data storage can be a database in which the input data can be stored. In other examples, the failed attempt sensor data storage can be cache in which data is stored temporarily for use of the sensor system.

If the gesture evaluation system determines that the inference data includes a positive inference with respect to the first gesture, the gesture evaluation system can initiate one or more actions based on the first gesture. For example, a first gesture can be associated with a navigation command (e.g., scrolling up/down/side, flipping a page, etc.) in one or more user interfaces coupled to the interactive object and/or one or more remote computing devices. In addition, or alternatively, the first gesture can initiate one or more predefined actions utilizing one or more computing devices, such as, for example, dialing a number, sending a text message, playing a sound recording, etc.

In some examples, when a positive inference is received for the first gesture, the gesture evaluation system or other system of the interactive object or computing system thereof can analyze any stored sensor data associated with a failed attempt to input a gesture in a period prior to receiving the positive inference (e.g., a reverse search through the stored sensor data). In some examples, the failed attempts can be analyzed based on when and in what order the failed attempts were received. For example, if a user attempts to input the first gesture on the touch sensor and receives a notification that the first gesture was not recognized, the user may immediately attempt to input the first gesture again. Thus, the interactive object can determine if any failed attempts received immediately prior to receiving the input that resulted in the positive inference were failed attempts to input the first gesture.

In another example, the sensor data for failed attempts can be analyzed based on the confidence value assigned to the first gesture by the machine-learned model. As noted above, the machine-learned model can output a list of candidate gestures with associated confidence values for a particular failed attempt to input a gesture. The gesture evaluation system can determine whether the first gesture is included in the list of candidate gestures. If so, the gesture evaluation system can determine whether the confidence value associated with the first gesture exceeds a second confidence value threshold. The second confidence value threshold can be lower than the first confidence value threshold and can be used to evaluate whether the failed attempts to input a gesture are associated with a later successfully identified gesture. For example, the first confidence value threshold can be 0.7 and the second confidence value threshold can be 0.3. In this example, a failed attempt to input a gesture can be determined to match the successful gesture if the confidence value is above 0.3. The first and second confidence value threshold can be set to other threshold values as needed or can be determined adaptively so as to achieve a certain level of identification of “failed” attempts to recategorize as “positives”.

If the system determines that one or more failed attempts to input a gesture correspond to the first gesture for which a positive inference was later received (e.g., based on the timing and sequence of those failed attempts and/or relative confidence values), those failed attempts can be used to generate additional training data. For example, the sensor data associated with the failed attempts can be annotated with labels or other information that indicate the sensor data corresponds to the first gesture (e.g., is a positive example of the first gesture). The labeled sensor data can be added to the existing training data as additional training data. This training data can represent positive examples of the first gesture being performed and can be used to train a machine-learned model to improve the accuracy of the machine-learned model when classifying touch input from a particular user.

The machine-learned model can be trained using the updated training data. The parameters of the machine-learned model can be updated to be more accurate in classifying the labeled input as being associated with the intended gesture. In this way, the machine-learned model stored on a particular user's device can be updated to identify gestures by a particular user more accurately without changing the machine-learned models associated with other users' devices. In some examples, this training can be referred to as updating or adjusting the machine-learned model as the model is not trained afresh. Instead, values associated with the machine-learned model can be adjusted. Additionally, or alternatively, this step can be referred to as “tuning” or “retuning” the machine-learned model.

The machine-learned classification model can be trained using various training or learning techniques, such as, for example, backward propagation of errors based on training data. Thus, when the machine-learned model is deployed to a particular sensor system it can have the same parameter values as all other machine-learned models for similar sensor systems. However, differences in users (both in user's preferences and user's abilities) can result in the machine-learned model having less accuracy for some users than others. Rather than adjust the parameter values for all machine-learned models, the sensor system can perform additional training for the specific machine-learned model on or associated with the user's object or device based on the input received from the particular user that uses the sensor system. Thus, each machine-learned model can be customized for a particular user of the sensor system based on the user's capabilities, style, flair, or preferences.

With reference now to the figures, example aspects of the present disclosure will be discussed in greater detail.

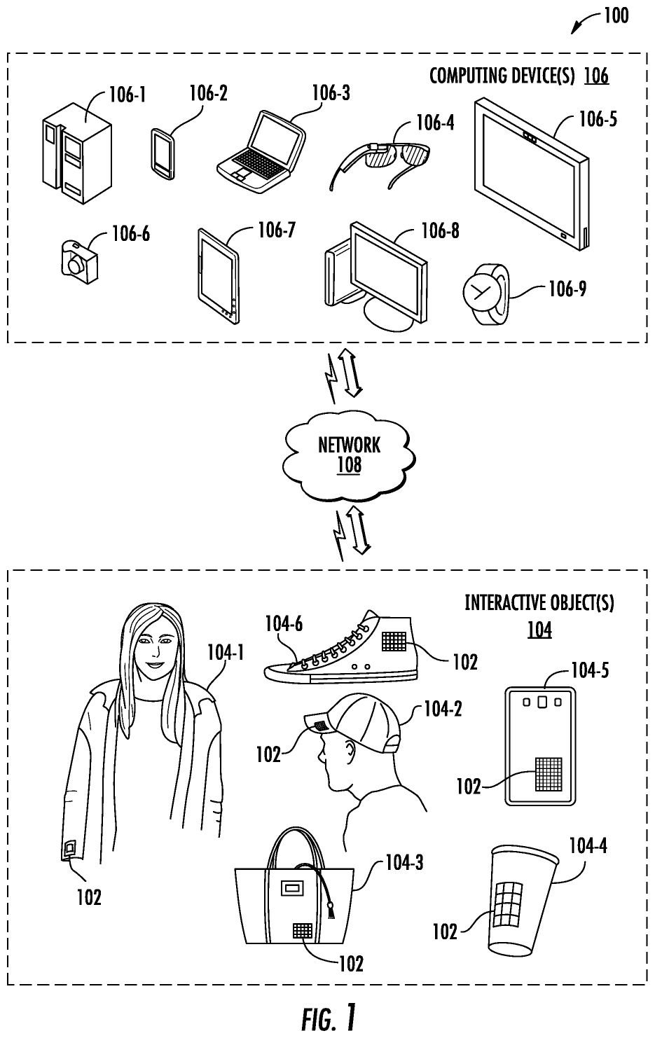

FIG. 1 is an illustration of an example environment 100 in which an interactive object including a touch sensor can be implemented. Environment 100 includes a touch sensor 102 (e.g., capacitive or resistive touch sensor), or another sensor. Touch sensor 102 is shown as being integrated within various interactive objects 104. Touch sensor 102 may include one or more sensing elements such as conductive threads or other sensing elements that are configured to detect a touch input.

In some examples, a capacitive touch sensor can be formed from an interactive textile which is a textile that is configured to sense multi-touch-input. As described herein, a textile corresponds to any type of flexible woven material consisting of a network of natural or artificial fibers, often referred to as thread or yarn. Textiles may be formed by weaving, knitting, crocheting, knotting, pressing threads together or consolidating fibers or filaments together in a nonwoven manner. A capacitive touch sensor can be formed from any suitable conductive material and in other manners, such as by using flexible conductive lines including metal lines, filaments, etc. attached to a non-woven substrate.

In environment 100, interactive objects 104 include “flexible” or “deformable” objects, such as a shirt 104-1, a hat 104-2, a handbag 104-3 and a shoe 104-6. It is to be noted, however, that touch sensor 102 may be integrated within any type of flexible object made from fabric or a similar flexible material, such as garments or articles of clothing, garment accessories, garment containers, blankets, shower curtains, towels, sheets, bedspreads, or fabric casings of furniture, to name just a few. Examples of garment accessories may include sweat-wicking elastic bands to be worn around the head, wrist, or bicep. Other examples of garment accessories may be found in various wrist, arm, shoulder, knee, leg, and hip braces or compression sleeves. Headwear is another example of a garment accessory, e.g. sun visors, caps, and thermal balaclavas. Examples of garment containers may include waist or hip pouches, backpacks, handbags, satchels, hanging garment bags, and totes. Garment containers may be worn or carried by a user, as in the case of a backpack, or may hold their own weight, as in rolling luggage. Touch sensor 102 may be integrated within flexible objects 104 in a variety of different ways, including weaving, sewing, gluing, and so forth. Flexible objects may also be referred to as “soft” objects.

In this example, objects 104 further include “hard” objects, such as a plastic cup 104-4 and a hard smart phone casing 104-5. It is to be noted, however, that hard objects 104 may include any type of “hard” or “rigid” object made from non-flexible or semi-flexible materials, such as plastic, metal, aluminum, and so on. For example, hard objects 104 may also include plastic chairs, water bottles, plastic balls, or car parts, to name just a few. In another example, hard objects 104 may also include garment accessories such as chest plates, helmets, goggles, shin guards, and elbow guards. Alternatively, the hard or semi-flexible garment accessory may be embodied by a shoe, cleat, boot, or sandal. Touch sensor 102 may be integrated within hard objects 104 using a variety of different manufacturing processes. In one or more implementations, injection molding is used to integrate touch sensors into hard objects 104.

Touch sensor 102 enables a user to control an object 104 with which the touch sensor 102 is integrated, or to control a variety of other computing devices 106 via a network 108. Computing devices 106 are illustrated with various non-limiting example devices: server 106-1, smartphone 106-2, laptop 106-3, computing spectacles 106-4, television 106-5, camera 106-6, tablet 106-7, desktop 106-8, and smart watch 106-9, though other devices may also be used, such as home automation and control systems, sound or entertainment systems, home appliances, security systems, netbooks, and e-readers. Note that computing device 106 can be wearable (e.g., computing spectacles and smart watches), non-wearable but mobile (e.g., laptops and tablets), or relatively immobile (e.g., desktops and servers). Computing device 106 may be a local computing device, such as a computing device that can be accessed over a Bluetooth connection, near-field communication connection, or other local-network connection. Computing device 106 may be a remote computing device, such as a computing device of a cloud computing system.

Network 108 includes one or more of many types of wireless or partly wireless communication networks, such as a local-area-network (LAN), a wireless local-area-network (WLAN), a personal-area-network (PAN), a wide-area-network (WAN), an intranet, the Internet, a peer-to-peer network, point-to-point network, a mesh network, and so forth.

Touch sensor 102 can interact with computing devices 106 by transmitting touch data or other sensor data through network 108. Additionally or alternatively, touch sensor 102 may transmit gesture data, movement data, or other data derived from sensor data generated by the touch sensor 102. Computing device 106 can use the touch data to control computing device 106 or applications at computing device 106. As an example, consider that touch sensor 102 integrated at shirt 104-1 may be configured to control the user's smartphone 106-2 in the user's pocket, television 106-5 in the user's home, smart watch 106-9 on the user's wrist, or various other appliances in the user's house, such as thermostats, lights, music, and so forth. For example, the user may be able to swipe up or down on touch sensor 102 integrated within the user's shirt 104-1 to cause the volume on television 106-5 to go up or down, to cause the temperature controlled by a thermostat in the user's house to increase or decrease, or to turn on and off lights in the user's house. Note that any type of touch, tap, swipe, hold, or stroke gesture may be recognized by touch sensor 102.

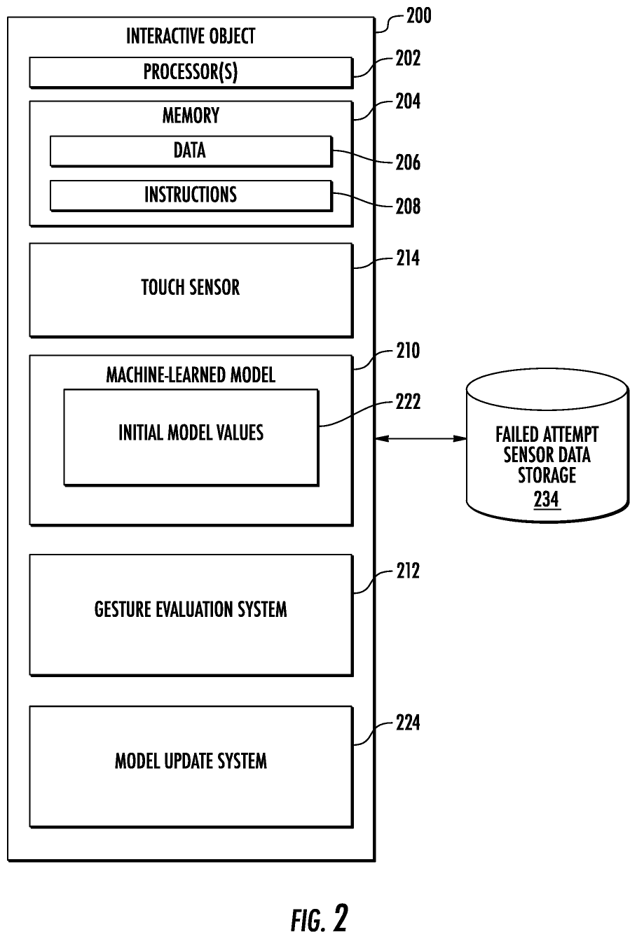

FIG. 2 illustrates an example computing environment including an interactive object 200 in accordance with example embodiments of the present disclosure. In this example, the interactive object 200 can include one or more processors 202, memory 204, a touch sensor 214, a machine-learned model 210, a gesture evaluation system 212, a model update system 224, and a failed attempt sensor data storage 234.

In more detail, the one or more processors 202 can be any suitable processing device that can be embedded in the form factor of an interactive object 200. For example, such a processor can include one or more of: one or more processor cores, a microprocessor, an ASIC, an FPGA, a controller, a microcontroller, etc. The one or more processors can be one processor or a plurality of processors that are operatively connected. The memory 204 can include one or more non-transitory computer-readable storage mediums, such as RAM, ROM, EEPROM, EPROM, flash memory devices, etc., and combinations thereof.

In particular, in some devices, memory 204 can store instructions 208 for implementing the machine-learned model 210, the gesture evaluation system 212, and/or the model update system 224.

It will be appreciated that the term “system” can refer to specialized hardware, computer logic that executes on a more general processor, or some combination thereof. Thus, a system can be implemented in hardware, application specific circuits, firmware, and/or software controlling a general-purpose processor. In one embodiment, the system can be implemented as program code files stored on the storage device, loaded into memory, and executed by a processor or can be provided from computer program products, for example computer executable instructions, that are stored in a tangible computer-readable storage medium such as RAM, hard disk or optical or magnetic media.

Memory 204 can also include data 206 that can be retrieved, manipulated, created, or stored by the one or more processor(s) 202. In some example embodiments, such data can be accessed and used as input to the machine-learned model 210, the gesture evaluation system 212, or the model update system 226. In some examples, the memory 204 can include data used to perform one or more processes and instructions that describe how those processes can be performed.

Touch sensor 214 is configured to sense input from a user when a touch input item (e.g., one or more fingers of the user's hand, a stylus, etc.) touches or approaches touch sensor 214. Touch sensor 214 may be configured as a capacitive touch sensor or resistive touch sensor to sense single-touch, multi-touch, and/or full-hand touch-input from a user. To enable the detection of touch-input, touch sensor 214 includes sensing elements. Sensing elements may have various shapes and geometries. In some implementations, the sensing elements do not alter the flexibility of touch sensor 214, which enables touch sensor 214 to be easily integrated within interactive objects 200.

The touch sensor 214 can be configured to generate sensor data in response to touch input from a user. The sensor data can be generated based, at least in part, on a response (e.g., resistance or capacitance) associated with sensing elements from each subset of sensing elements.

Other input sensors can be included in the object 200 in addition or alternatively to the touch sensor 214. For example, the object 200 can include a sensor that uses radio detection and ranging (RADAR) technology to collect or generate sensor data. A user can provide user input by making a gesture near the object 200 which can be represented by RADAR sensor data collected by the RADAR sensor. While the remainder of the discussion with respect to certain figures of the present disclosure will focus on touch inputs or touch-based sensor data, such discussion is equally applicable to user inputs and corresponding sensor data that represents such user inputs of any modality, including RADAR sensor data as described above.

In some examples, the interactive object 200 can provide the touch data from each touch input to a machine-learned model 210. The machine-learned model 210 can be trained to output inference data based on the input. The machine-learned model 210 can have a plurality of initial model values 222. The initial model values 222 can include parameters for the machine-learned model 210. The parameters of a machine-learned model can include but are not limited to: the number of layers, the number of nodes, the connections between nodes, the weight of each connection, the weight of each node, and so on.

The inference data can indicate whether the sensor data corresponds to a particular gesture. For example, the inference data can include a positive inference that the sensor data corresponds to a particular gesture. Alternatively, the inference data can include a negative inference. A negative inference can indicate that the sensor data does not correspond to a particular gesture. In some examples, a negative inference can indicate that the sensor data does not correspond to any gesture that the machine-learned model has been trained to recognize. In some examples, the inference can be indicated via one-hot encoding, such that the outputted data includes a string of bit values, each bit value associated with a particular gesture. One of the bit values in the string of bit values can be set to “high” (e.g., set to logical 1). The gesture associated with the bit that has been set to “high” is the gesture that corresponds to the sensor data. Other output structures can include a logit or softmax output and a one-hot encoding can be generated from the logit or softmax output by applying thresholding rules.

Thus, in some examples, the inference output can include a list of more than one candidate gesture. In this case, the machine-learned model 210 can output a list of candidate gestures and a confidence value associated with each respective candidate gesture. In this example, the machine-learned model can be trained to output both one or more candidate gestures and, for each respective candidate gesture, an associated confidence value. The confidence value associated with a particular candidate gesture can represent the degree to which the touch data is associated with the particular candidate gesture, such that the higher the confidence value, the more likely the touch input was intended to be the candidate gesture.

The inference data outputted by the machine-learned model 210 can be transmitted to the gesture evaluation system 212. If more than one gesture is indicated by the inference output by the machine-learned model 210, the gesture evaluation system 212 can determine which gesture, if any, corresponds to the inference output. For example, the gesture evaluation system 212 can determine that the gesture that corresponds to the touch input is the gesture with the highest confidence value and/or exceeds a threshold value. Additionally or alternatively, the gesture evaluation system 212 can determine whether any of the candidate gestures have a confidence value that exceeds a first confidence value threshold. If no candidate gestures have a confidence value that exceeds the first confidence value threshold, the gesture evaluation system 212 can determine that no gesture corresponds to the touch input. In some examples, the touch input can be determined to be a failed touch input if none of the candidate gestures have a value above the first candidate value threshold.

In some implementations, if none of the candidate gestures have a confidence value that exceeds the first confidence value threshold, the gesture evaluation system 212 can designate the touch input as a failed attempt to input a gesture input. In some examples, the gesture evaluation system 212 can provide feedback to the user that indicates that the touch input has resulted in a failed attempt (e.g., an audio notification or notification on a screen of an associated computing device, a haptic feedback, etc.). The touch data generated by the touch sensor 214 can be stored as failed attempt data in a failed attempt sensor data storage 234. For example, the gesture evaluation system 212 can include a failed attempt buffer (e.g., implemented either in hardware or in software) that stores sensor data associated with failed attempts received from the touch sensor 214 that are not determined to be associated with any particular gesture. In some examples, the failed attempt sensor data storage 234 can store failed attempt sensor data for a particular amount of time. In other examples, the failed attempt sensor data storage 234 can store failed attempt data until a gesture is successfully identified. In some examples, a combination of these two methods can be used (e.g., failed input data is discarded after a certain amount of time or after a successful gesture is identified).

In some examples, when a first gesture is successfully determined to correspond to touch input based on the inference data output by the machine-learned model, the gesture evaluation system 212 can perform a reverse search of the failed attempt data in the failed attempt sensor data storage 234 to determine whether any of the failed attempts were attempts to input the first gesture. In some examples, the failed attempts can be determined based on an analysis of when and in what order the failed attempts were received. For example, if a user attempts to make a gesture on the touch sensor 214 and receives a notification that the input was a failed attempt, the user may immediately make the gesture again. Thus, the gesture evaluation system 212 can determine that the failed gesture is an attempt to input the later successful gesture.

In other examples, the data associated with failed attempts stored in the failed attempt sensor data storage 234 can be analyzed based on the list of one or more candidate gestures output by the machine-learned model and the confidence values associated with each candidate gesture. For example, each failed gesture attempt can have inference data output by the machine-learned model 210 including a list of candidate gestures each with their associated confidence values. Because the touch input was determined to be a failed attempt, none of the candidate gestures have a confidence value above the first confidence value threshold. However, the gesture evaluation system 212 can include a second confidence value threshold that is lower than the confidence value threshold and can be used to evaluate whether the failed inputs are associated with a later successful input. For example, the confidence value threshold can be 0.7 and the secondary confidence value threshold can be 0.3. In this example, a failed gesture attempt can be determined to correspond to the successful gesture if the confidence value is above 0.3 (wherein the confidence values are values between 0 and 1).

If the gesture evaluation system 212 determines that one or more failed attempts stored in the failed attempt sensor data storage 234 correspond to the first gesture, sensor data associated with the corresponding failed attempts can be passed to the model update system 224. The model update system 224 can annotate the sensor data associated with the failed attempts with one or more labels indicating that the sensor data associated with the failed attempts are examples of the first gesture and can be added to the existing training data as labeled data. Labeled data can represent positive examples of the gesture being performed and can be used by the model update system 224 to train the local version of the machine-learned model 210 to improve the machine-learned model's 210 ability to accurately classify touch input from a particular user as corresponding to a particular predetermined gesture. Thus, the local version of the machine-learned model 210 can be updated by training it with the additional labeled data such that one or more parameters associated with the model are updated and/or changed. The updated machine-learned model 210 can be more accurate in classifying the labeled input as corresponding to the intended predetermined gesture. In this way, the machine-learned model 210 stored on a particular interactive object 200 can be updated in real-time to identify gestures by particular users more accurately without changing the machine-learned models associated with other users' devices. Training of the model 210 by the model update system 224 can include backpropagating a classification loss to update the values 222 of the parameters of the model 210. For example, the classification loss can be calculated with respect to predictions generated for the additional labeled data. Example loss functions include mean squared error, likelihood loss, cross entropy loss, hinge loss, and/or various other loss functions

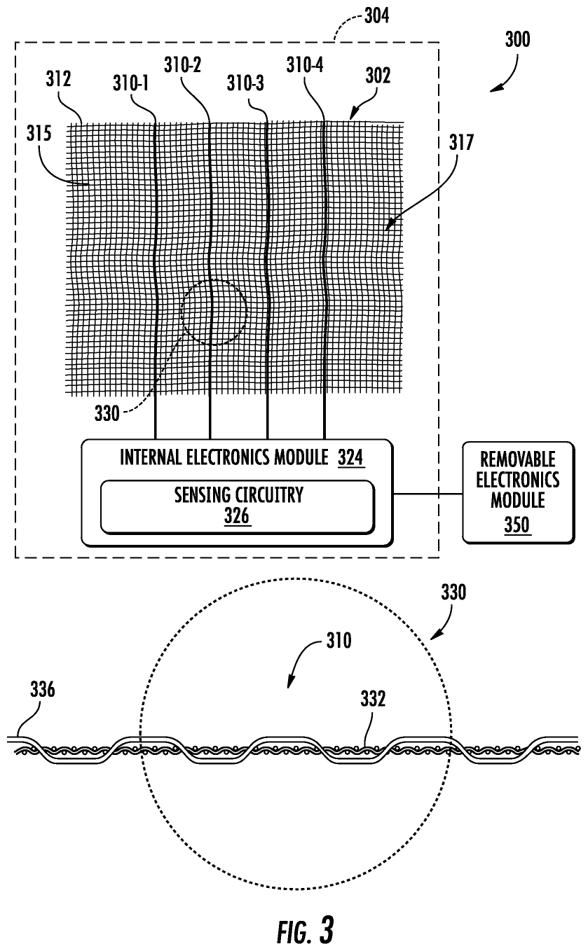

FIG. 3 illustrates an example of a sensor system 300, such as can be integrated with an interactive object 304 in accordance with one or more implementations. In this example, the sensing elements implemented as conductive threads 310 (e.g., any of 310-1, 310-2, 310-3, or 310-4) on or within a substrate 315. Touch sensor 302 includes non-conductive threads 312 woven with conductive threads 310 to form a capacitive touch sensor 302 (e.g., interactive textile). It is noted that a similar arrangement may be used to form a resistive touch sensor. Non-conductive threads 312 may correspond to any type of non-conductive thread, fiber, or fabric, such as cotton, wool, silk, nylon, polyester, and so forth.

At 330, a zoomed-in view of conductive thread 310 is illustrated. Conductive thread 310 includes a conductive wire 336 or a plurality of conductive filaments that are twisted, braided, or wrapped with a flexible thread 332. As shown, the conductive thread 310 can be woven with or otherwise integrated with the non-conductive threads 312 to form a fabric or a textile. Although a conductive thread and textile is illustrated, it will be appreciated that other types of sensing elements and substrates may be used, such as flexible metal lines formed on a plastic substrate.

In one or more implementations, conductive wire 336 is a thin copper wire. It is to be noted, however, that the conductive wire 330 may also be implemented using other materials, such as silver, gold, or other materials coated with a conductive polymer. The conductive wire 330 may include an outer cover layer formed by braiding together non-conductive threads. The flexible thread 333 may be implemented as any type of flexible thread or fiber, such as cotton, wool, silk, nylon, polyester, and so forth.

Capacitive touch sensor 302 can be formed cost-effectively and efficiently, using any conventional weaving process (e.g., jacquard weaving or 3D-weaving), which involves interlacing a set of longer threads (called the warp) with a set of crossing threads (called the weft). Weaving may be implemented on a frame or machine known as a loom, of which there are a number of types. Thus, a loom can weave non-conductive threads 312 with conductive threads 310 to create a capacitive touch sensor 302. In another example, capacitive touch sensor 303 can be formed using a predefined arrangement of sensing lines formed from a conductive fabric such as an electro-magnetic fabric including one or more metal layers.

The conductive threads 310 can be formed into the touch sensor 302 in any suitable pattern or array. In one embodiment, for instance, the conductive threads 310 may form a single series of parallel threads. For instance, in one embodiment, the capacitive touch sensor may comprise a single plurality of parallel conductive threads conveniently located on the interactive object, such as on the sleeve of a jacket.

In example system 300, sensing circuitry 326 is shown as being integrated within object 104, and is directly connected to conductive threads 310. During operation, sensing circuitry 326 can determine positions of touch-input on the conductive threads 310 using self-capacitance sensing or mutual capacitive sensing.

For example, when configured as a self-capacitance sensor, sensing circuitry 326 charges can charge a selected conductive thread 310 by applying a control signal (e.g., a sine signal) to the selected conductive thread 310. The control signal may be referred to as a scanning voltage in some examples and the processing of determining the capacitance of a selected conductive thread may be referred to as scanning. In some examples, the control signal can be applied to a selected conductive thread while grounding or applying a low-level voltage to the other conductive threads. When an object, such as the user's finger, touches the grid of conductive thread 310, the capacitive coupling between the conductive thread 310 that is being scanned and system ground may be increased, which changes the capacitance sensed by the touched conductive thread 310. This process can be repeated by applying the scanning voltage to each selected conductive thread while grounding the remaining non-selected conductive threads. In some examples, the conductive threads can be scanned individually, proceeding through the set of conductive threads in sequence. In other examples, more than one conductive thread may be scanned simultaneously.

Sensing circuitry 326 uses the change in capacitance to identify the presence of the object (e.g., user's finger, stylus, etc.). When an object, such as the user's finger, touches the grid of conductive thread, the capacitance changes on the conductive threads (e.g., increases or decreases). Sensing circuitry 326 uses the change in capacitance on conductive threads to identify the presence of the object. To do so, sensing circuitry 136 detects a position of the touch-input by scanning the conductive threads to detect changes in capacitance. Sensing circuitry 326 determines the position of the touch-input based on conductive threads having a changed capacitance. Other sensing techniques such as mutual capacitive sensing may be used in example embodiments.

The conductive thread 310 and sensing circuitry 326 is configured to communicate the touch data that is representative of the detected touch-input to a machine-learned model gesture manager 210 (e.g., machine-learned model 210 in FIG. 2). The machine-learned model 210 may then determine gestures based on the touch data, which can be used to control object 104, computing device 106, or applications implemented at computing device 106. In some implementations, a predefined motion may be determined by the internal electronics module 324 and/or the removable electronics module 350 and data indicative of the predefined motion can be communicated to a computing device 106 to control object 104, computing device 106, or applications implemented at computing device 106.

In accordance with some embodiments, a plurality of sensing lines can be formed from a multilayered flexible film to facilitate a flexible sensing line. For example, the multilayered film may include one or more flexible base layers such as a flexible textile, plastic, or other flexible material. One or more metal layers may extend over the flexible base layer(s). Optionally, one or more passivation layers can extend over the one or more flexible base layers and the one or more metal layer(s) to promote adhesion between the metal layer(s) and the base layer(s). In accordance with some examples, a multilayered sheet including one or more flexible base layers, one or more metal layers, and optionally one or more passivation layers can be formed and then cut, etched, or otherwise divided into individual sensing lines. Each sensing line can include a line of the one or more metal layers formed over a line of the one or more flexible base layers. Optionally, a sensing line can include a line of one or more passivation layers overlying the one or more flexible base layers. An electromagnetic field shielding fabric can be used to form the sensing lines in some examples.

The plurality of conductive threads 310 forming touch sensor 303 are integrated with non-conductive threads 312 to form flexible substrate 315 having a first surface 317, opposite a second side (or surface) in a direction orthogonal to the first side and the second side. Any number of conductive threads may be used to form a touch sensor. Moreover, any number of conductive threads may be used to form the plurality of first conductive threads and the plurality of second conductive threads. Additionally, the flexible substrate may be formed from one or more layers. For instance, the conductive threads may be woven with multiple layers of non-conductive threads. In this example, the conductive threads are formed on the first surface only. In other examples, a first set of conductive threads can be formed on the first surface and a second set of conductive threads at least partially formed on the second surface.

One or more control circuits of the sensor system 300 can obtain touch data associated with a touch input to touch sensor 302. The one or more control circuits can include sensing circuitry 326 and/or a computing device such as a microprocessor at the internal electronics module 324, microprocessor at the removable electronics module 350, and/or a remote computing device 106. The one or more control circuits can implement a gesture manager in example embodiments. The touch data can include data associated with a respective response by each of the plurality of conductive threads 310. The touch data can include, for example, a capacitance associated with conductive threads 310-1, 310-3, 310-3, and 310-4. In some examples, the control circuit(s) can determine whether the touch input is associated with a first subset of conductive threads exposed on the first surface or a second subset of conductive threads exposed on the second surface. The control circuit(s) can classify the touch input as associated with a particular subset based at least in part on the respective response to the touch input by the plurality of conductive sensing elements.

The control circuits(s) can be configured to detect a surface of the touch sensor at which a touch input is received, detect one or more gestures or other user movements in response to touch data associated with a touch input, and/or initiate one or more actions in response to detecting the gesture or other user movement. By way of example, control circuit(s) can obtain touch data that is generated in response to a touch input to touch sensor 302. The touch data can be based at least in part on a response (e.g., resistance or capacitance) associated with sensing elements from each subset of sensing elements. The control circuit(s) can determine whether the touch input is associated with a first surface of the touch sensor or a second surface of the touch sensor based at least in part on the response associated with the first sensing element and the response associated with the second sensing element. The control circuit(s) can selectively determine whether a touch input corresponds to a particular input gesture based at least in part on whether the touch input is determined to have been received at a first surface of the touch sensor or a second surface of the touch sensor. Notably, the control circuit(s) can analyze the touch data from each subset of sensing elements to determine whether a particular gesture has been performed. In this regard, the control circuits can utilize the individual subsets of elements to identify the particular surface of the touch sensor. However, the control circuits can utilize the full set of sensing elements to identify whether a gesture has been performed.

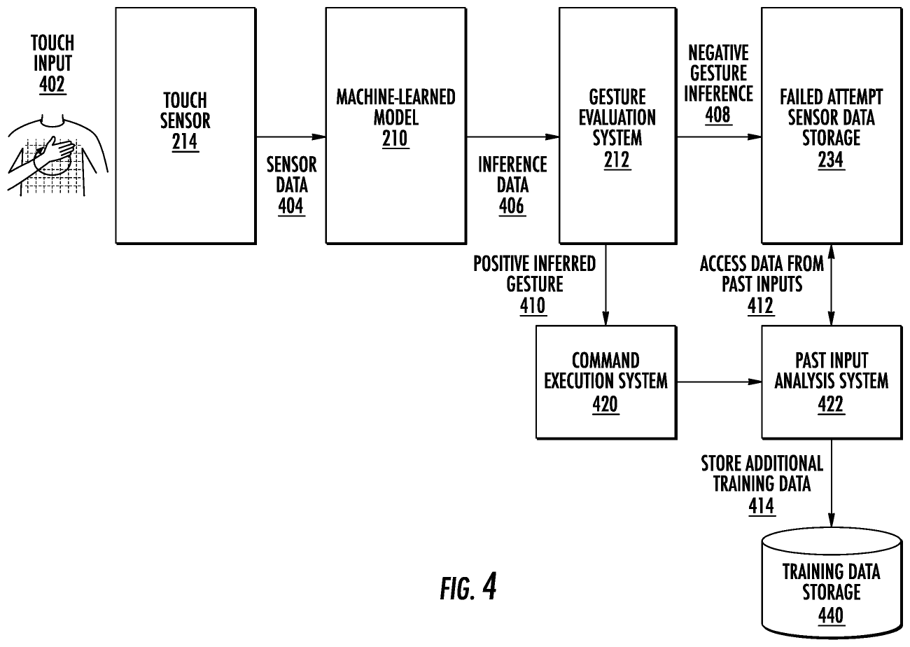

FIG. 4 illustrates an example system for updating a machine-learned model 210 based on failed attempts to input a gesture in accordance with example embodiments of the present disclosure. In this example, a user can provide touch input 402. In this example, the touch input can be a circular gesture by a user on the chest/stomach of a shirt with an embedded touch sensor. The disclosed technology can be especially advantageous in large deformable interactive objects (e.g., sensors included in a piece of clothing). Specifically, the deformability of the clothing can result in specific difficulties when inputting touch gestures. Thus, the present teachings can be particularly advantageous for wearables having various novel or relatively unconventional input sensor form factors, especially larger form factors involving gestures of larger physical scale, with which users may be less familiar, and/or that have been created for persons with disabilities, be they special one-time patterns or more common wearable items.

The touch sensor 214 can be a capacitive touch sensor or any other type of sensor capable of generating data based on the touch of a user. In response to the touch input 402, the touch sensor 214 can generate sensor data 404 (e.g., touch data) and provide it as input to the machine-learned model 210.

The machine-learned model 210 can output inference data 406 based on the input sensor data 404. In some examples, the inference data can include a positive inference that the sensor data 404 corresponds to a particular gesture. Alternatively, the inference data 406 can include a negative inference. A negative inference can indicate that the sensor data 404 does not correspond to the particular gesture. In some examples, a negative inference can indicate that the sensor data 404 does not correspond to any gesture that the machine-learned model has been trained to recognize.

In some examples, the inference data 406 includes a list of candidate gestures and, for each candidate gesture, a confidence value. The confidence value can represent the likelihood or certainty that the sensor data 404 corresponds to a particular attempted gesture by the user. For example, a list of candidate gestures can include three candidate gestures, a right swipe gesture, a left swipe gesture, and a tap gesture. The right swipe gesture can have a confidence value of 0.8, the left swipe gesture can have a confidence value of 0.12, and the tap gesture can have a confidence value of 0.08. In this particular example, the touch input can be more likely to correspond to the right swipe gesture than the left swipe gesture or the tap gesture.

The inference data 406 can be output by the machine-learned model 210 and passed to the gesture evaluation system 212. The gesture evaluation system 212 can determine whether the inference data 406 corresponds to at least one gesture. For example, the inference data 406 can include a positive inference that the touch input corresponds to a single gesture. However, in some examples, the inference data 406 can include a plurality of candidate gestures. Each candidate gesture can have an associated confidence value. The gesture evaluation system 212 can determine whether any of the candidate gestures have an associated confidence value that exceeds a first confidence value threshold.

Using the previous example, if the first confidence value threshold is set to 0.7, the gesture evaluation system 212 can determine that the right swipe gesture (with a confidence value of 0.8) has a confidence value that exceeds the first confidence value threshold (0.8>0.7.) In some examples, if the inference data 406 includes a negative inference, indicating that the touch input does not correspond to a particular gesture or does not correspond to any gesture for which the machine-learned model has been trained. For example, a negative inference can include a determination that no candidate gestures have an associated confidence value that exceeds the first confidence value threshold. If the inference data 406 includes a negative inference, the gesture evaluation system 212 can determine that the input associated with the inference is a failed attempt to input a gesture.

In some examples, if the gesture evaluation system 212 determines that the inference data 406 includes a negative inference, the gesture evaluation system 212 can transmit data associated with the failed attempt to the failed attempt sensor data storage 234. For example, the failed attempt sensor data storage 234 can store inference data 406 output by the machine-learned model 210. In addition, the failed attempt sensor data storage 234 can store the sensor data 404 generated by the touch sensor 214 in response to touch input. In some examples, the interactive object 200 can provide feedback to the user to alert the user that the received touch input was not successfully identified as a particular gesture. For example, the interactive object 200 can generate an auditory “fail” sound or other method of notifying the user. The user can repeat the same gesture in an attempt to enable the interactive object 200 to identify the intended gesture.

In some examples, if the gesture evaluation system 212 determines that the inference data 406 includes a positive inference that corresponds the touch input with a first gesture, the gesture evaluation system 212 can transmit data representing a positive inferred gesture 410 to the command execution system 420. The command execution system 420 can cause a user computing device associated with an interactive object 200 to perform one or more actions associated with the positive inferred gesture 410. For example, the command execution system 420 can initiate one or more predefined actions utilizing one or more computing devices, such as, for example, dialing a number, sending a text message, playing a sound recording, etc.

In addition, after the touch input is determined to correspond to a first gesture by the gesture evaluation system 212, the command execution system 420 can initiate the past input analysis system 422. The past input analysis system 422 can access data from past inputs 412 from the failed attempt sensor data storage 234. The past input analysis system 422 can perform a reverse search of the failed attempt data to determine whether any of the failed inputs were attempts to input the first gesture. In some examples, the failed attempt s can be analyzed to determine when and in what order the failed inputs were received. For example, if a user makes the first gesture on the touch sensor 214 and receives a notification that the input was a failed attempt, the user may immediately make the gesture again. Thus, the past input analysis system 422 can determine that the failed gesture is an attempt to input the later successful gesture.

In other examples, the data associated with failed attempts stored in the failed attempt sensor data storage 234 can be analyzed to determine whether any of the failed attempts correspond to the positively inferred gesture 410. For example, the past input analysis system 422 can access data from past inputs 412 that were determined to be failed attempts to input a gesture. In some examples, the past input analysis system 422 can determine that one or more failed attempts correspond to the positive inferred gesture 410 based on the timing that the failed attempts were received. For example, the past input analysis system 422 can determine that any failed attempt that occurred within a predetermined period of time (e.g., 15 seconds) of when the successful gesture was detected is determined to correspond to the successful gesture.

Additionally or alternatively, the past input analysis system 422 can determine whether failed attempts correspond with the successful attempt based on whether a pause or break occurred between the one or more failed attempts and the successful attempt. For example, if a failed attempt is detected and then a long pause (e.g., more than 10 seconds) occurs before the successful attempt, the past input analysis system 422 can determine that the failed attempt does not necessarily correspond to the successful attempt even if it occurred within the predetermined period because of the long (e.g., 12 second) pause between the failed attempt and the successful attempt. Similarly, if several failed attempts occur in quick succession, the past input analysis system 422 can determine that all such inputs correspond to the successfully detected gesture even if some of the failed attempts occur outside of the normal predetermined period. For example, if a user makes nine failed attempts, each beginning immediately after the previous attempt failed (e.g., based on feedback from the interactive object), the past input analysis system 422 can determine all nine attempts correspond to the successful attempt even if some of them occur outside of the predetermined period.

Additionally or alternatively, the past input analysis system 422 can determine that past failed attempts correspond to the successfully detected gestures based, at least in part, on a list of candidate gestures for the failed attempts and their respective confidence values. Thus, a particular failed attempt may have a list of candidate gestures and each candidate gesture can have an associated confidence value. Because the input was determined to be a failed attempt, none of the candidate gestures have a confidence value above the first confidence value threshold. However, the past input analysis system 422 can include a second confidence value threshold that is lower than the first confidence value threshold. The past input analysis system 422 can use the second confidence value threshold to evaluate whether the touch input associated with the failed attempts corresponds to the later successful input (e.g., the first gesture). For example, the first confidence value threshold can be 0.7 and the second confidence value threshold can be 0.3. In this example, a touch input associated with a failed attempt can be determined to correspond to the successful gesture if the corresponding confidence value is above 0.3.

In some examples, if the successful input corresponded to a first gesture, one or more failed attempts that occurred within a predetermined period before the successful input was detected can be analyzed to determine whether the confidence value associated with the first gesture exceeds the secondary confidence value threshold. If so, the interactive object 200 can determine that the touch input for the one or more failed attempts corresponds to the first gesture.

If the interactive object 200 identifies one or more touch inputs from failed attempts that correspond to the first gesture, the one or more touch inputs can be annotated with labels indicating that they represent attempts to input the first gesture. Once annotated with labels, the one or more touch inputs from failed attempts can be added to the existing training data as labeled data in the training data storage 440. Labeled data can represent positive examples of the gesture being performed and can be used to train the machine-learned model 210 to improve the model's 210 ability to accurately classify touch input from a particular user as particular predetermined gestures. Thus, the machine-learned model 210 can be trained using the additional training data such that one or more parameters associated with the model can be updated. The updated machine-learned model 210 can be more accurate in classifying the labeled input as being associated with the intended predetermined gesture. In this way, the machine-learned model 210 stored on a particular user's device can be updated in real-time to identify gestures by that particular user more accurately without changing the machine-learned models associated with other users' devices.

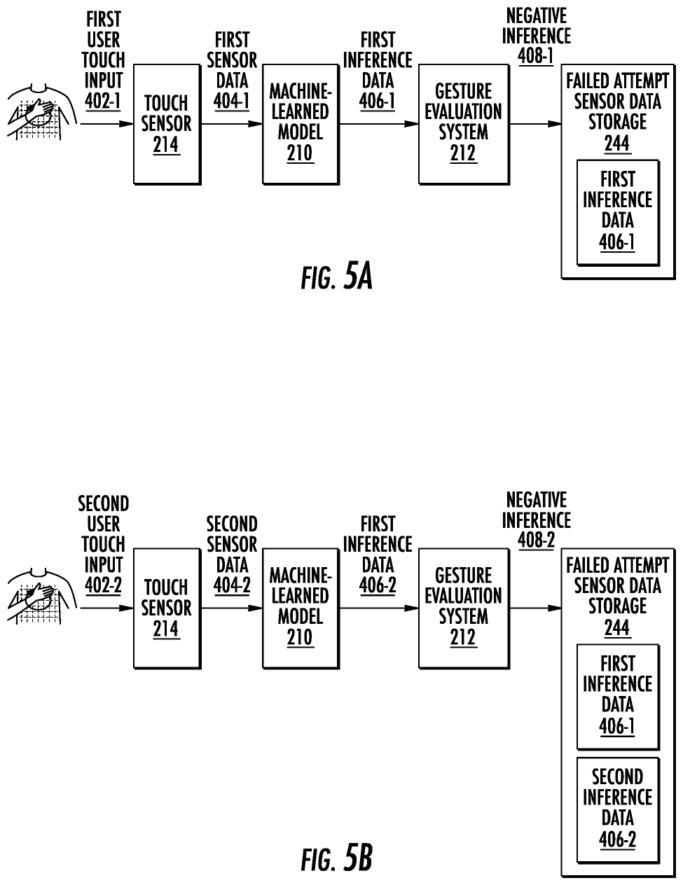

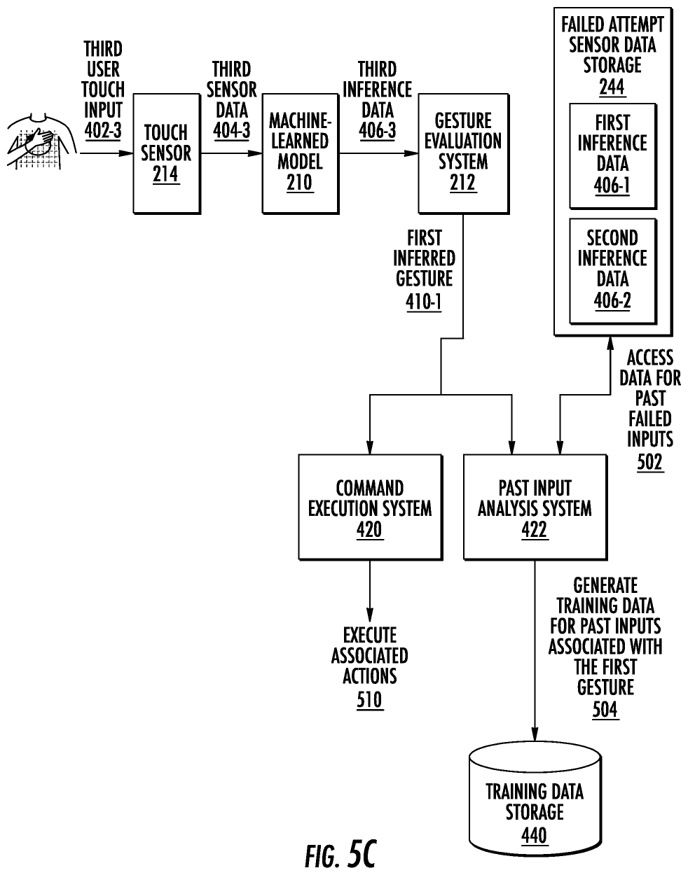

FIG. 5A illustrates an example process for evaluating touch inputs in accordance with example embodiments of the present disclosure. In this example, first user touch input 402-1 can be input by a user to the touch sensor 214. Based on the touch input 402-1, the touch sensor 414 can generate first sensor data 404-1. The first sensor data 404-1 one can be transmitted from the touch sensor 214 to the machine-learned model 210.

The machine-learned model 210 can take the first sensor data 404-1 as input and output first inference data 406-1. The first inference data 406-1 can be transmitted to the gesture evaluation system 212. The gesture evaluation system 212 can determine whether the first inference data 406-1 includes a positive or negative inference indicating that the first sensor data 404-1 does or does not correspond to a gesture that the machine-learned model is trained to recognize. For example, the gesture evaluation system 212 can determine, for a plurality of candidate gestures included in the first inference data 406-1, whether the confidence value associated with any of the account candidate gestures exceeds a first confidence value.

In this example, the gesture evaluation system 212 determines that the first inference data 406-1 includes a negative inference such that no gesture is determined to correspond to the first sensor data 404-1 based on the first inference data 406-1. In response to determining that the first inference data 406-1 includes a negative inference, the gesture evaluation system 212 can transmit first inference data 306-1 to the failed attempt sensor data storage 234 for storage. In some examples, the failed attempt sensor data storage 234 can also store first sensor data 304-1.

FIG. 5B illustrates an example process for evaluating touch inputs in accordance with example embodiments of the present disclosure. Continuing the example from FIG. 5A, a second user touch input 402-2 can be received based on a user's interaction with the touch sensor 214. In this example, the first user touch input 402-1 did not result in a gesture being identified by the interactive object. As a result, second user touch input 402-2 can be a second attempt by the user to input the desired gesture.

The touch sensor 214 can generate second sensor data 404-2. The second sensor data 404-2 can be used as input to a machine-learned model 210. The machine-learned model 210 can generate second inference data 406-2. The second inference data 406-2 can be passed to a gesture evaluation system 212. In this example, the gesture evaluation system 212 can determine that the second inference data 406-2 contains a negative reference and thus does not correspond to any gesture that the machine-learned model 210 has been trained to recognize. Because the second inference data 406-2 contained a negative inference 408-2, the gesture evaluation system 212 can store second inference data 406-2 in the failed attempt sensor data storage 234. As with the first inference data 406-1, second sensor data 404-2 can also be stored with the second inference data 406-2.

FIG. 5C illustrates an example process for evaluating touch inputs in accordance with example embodiments of the present disclosure. Continuing the example from FIG. 5A and 5B, a third user touch input 402-3 can be received based on a user's interaction with the touch sensor 214. In this example, the first user touch input 402-1 and second user touch input 402-2 did not result in a gesture being identified by the interactive object 200. As a result, the third user touch input 402-3 can be a third attempt by the user to input the desired gesture (e.g., a pinch gesture).

In this example, the third user touch input 402-3 is detected by the touch sensor 214. The touch sensor 214 can generate third sensor data 404-3 based on detected third user touch input 402-3. The third sensor data 404-3 can be used as input to the machine-learned model 210. The machine-learned model 210 can output third inference data 406-3.

In this example, the third inference data 406-3 can be evaluated by the gesture evaluation system 212 to determine whether the third inference data 406-3 includes a positive or negative inference. In this example, the gesture evaluation system 212 determines that the third inference data 406-3 includes a positive inference for the first gesture 410-1. The inferred first gesture 410-1 can be transmitted to the command execution system 420. Based on the specific gesture that was identified, the command execution system 420 can execute one or more associated actions 510.

In addition to transmitting the first inferred gesture 510-1 to the command execution system 420, the gesture evaluation system 212 can transmit the first inferred gesture 410-1 to the past input analysis system 422. The past input analysis system 422 can access inference data from past failed inputs from the failed attempt sensor data storage 234. In this example, the past input analysis system 422 can access data for the first inference data 406-1 and the second inference data 406-2 stored in the failed attempt sensor data storage 234.

The past input analysis system 422 can analyze the data from past failed inputs to determine whether or not they are associated with the first inferred gesture 410-1. As noted above this determination can be determined using a plurality of methods including analyzing the time and order in which the corresponding failed attempts were received (e.g., touch inputs associated with failed attempts that were received immediately before the successful input are much more likely to be associated with the gesture that was successfully identified.) In other examples, the stored inference data can include confidence values for one or more failed attempts. The past input analysis system 422 can determine whether the confidence values for the first inferred gesture 410-1 in the first inference data 406-1 and the second inference data 406-2 exceed a second confidence value threshold.

In accordance with the determination that one or more of the first inference data 406-1 and the second inference data 406-2 have confidence values that exceed the second confidence value threshold for the first inferred gesture 410-1, the past input analysis system 422 can generate new training data by annotating the first sensor data 404-1 and the second sensor data 404-2 with labels corresponding to the first inferred gesture 410-1. The annotated sensor data can be stored in the training data storage 440 for use when the machine-learned model 210 is updated.

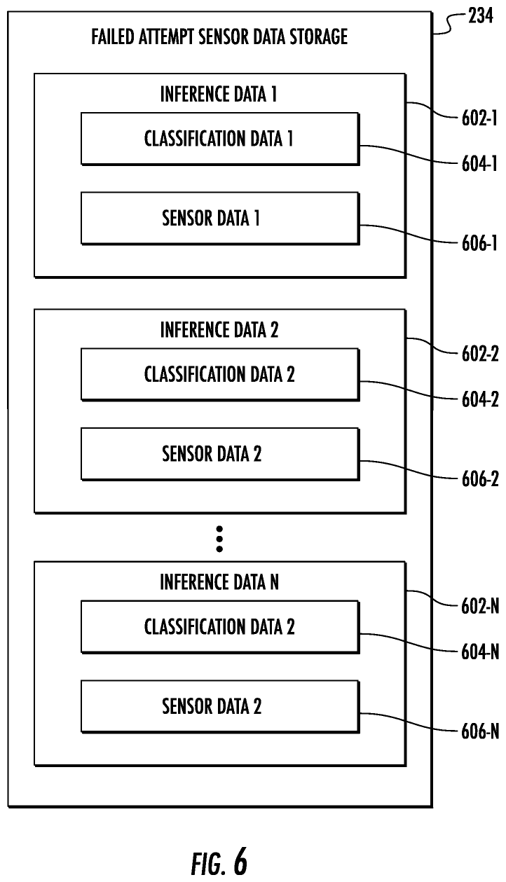

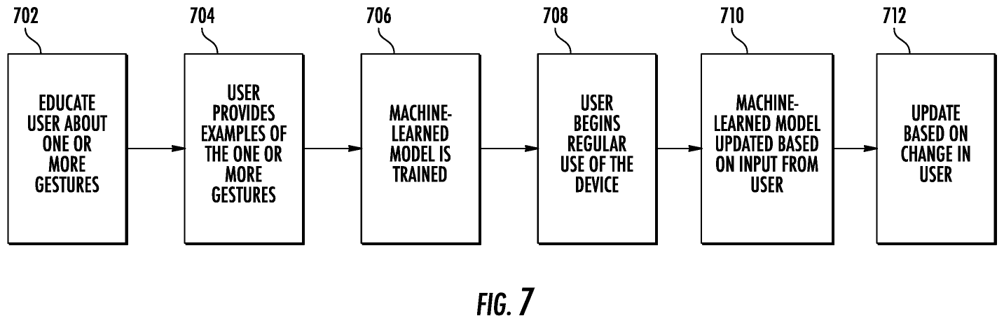

FIG. 6 illustrates a block diagram of an example failed attempt sensor data storage 234 in accordance with example embodiments of the present disclosure. The failed attempt sensor data storage 234 can include a plurality of inference data records (602-1, 602-2, and 602-N). In some examples, the inference data (e.g., one of 602-1, 602-2, and 602-N) can include classification data (604-1, 604-2, or 604-N). Classification data (604-1, 604-2, or 604-N) can include one or more candidate gestures. Each candidate gesture can have an associated confidence value.

In some examples, the inference data (e.g., one of 602-1, 602-2, and 602-N) for a particular failed attempt to enter a gesture can also include the sensor data (e.g., one of 606-1, 606-2, and 606-N) generated by the touch sensor 214 in response to the touch input from the user. In some examples, the inference data records (602-1, 602-2, and 602-N) for failed attempts can be retained for a particular period of time. In other examples, the inference data records (602-1, 602-2, and 602-N) for failed attempts can be retained until a gesture is successfully identified.

FIG. 7 illustrates a flow chart depicting an example process for enabling an interactive object 200 to receive touch inputs from a user and accurately determine associated gestures in accordance with example embodiments of the present disclosure. In this example, an interactive object (potentially communicatively coupled to a computing system) and an associated application can educate a user about one or more gestures 702. For example, one or more gestures associated with particular actions can be displayed to the user (e.g., in a display of an associated computing system) for reference.

The interactive object 200 or an associated computing system can request that the user provide examples of the one or more gestures 706 that are displayed to the user. For example, the user is requested to perform a gesture on a touch sensor associated with the interactive object after the specific gesture has been communicated to the user. The interactive object 200 can generate sensor data based on touch input and analyze the sensor data to determine whether the user is correctly inputting the gestures.

A machine-learned model stored on the interactive object 200 or a corresponding computing system can be trained based, at least in part, on the user's examples of the gestures 706. Thus the machine-learned model can adapt to the inputs provided by the user. Once the machine-learned model has been trained it can be used to identify intended gestures based on sensor data captured by the touch sensor in response to touch input from a user.

Once the user has learned the gestures and provided examples to train the machine-learned model, the user can start to use the interactive object 708 and/or the associated computing system. As the user uses the interactive object, the parameters of the machine-learned model) can further be trained and adjusted to customize the local copy of the machine-learned model to the abilities and preferences of the specific user 710.

In some examples, the parameters determined while training the machine-learned model based on input from a first user can be forgotten and the machine-learned model can be retrained for second user 712 (e.g., when the primary user of the interactive object changes). In other examples, if multiple users interact with a shared device or interactive object, the distance versions of the locally stored machine-learned model can be created (or at least distinct parameter values) for each user of the shared device 714. In this way, the preferences or abilities of a first user will not affect the machine-learned model trained to interpret the input of a second user.

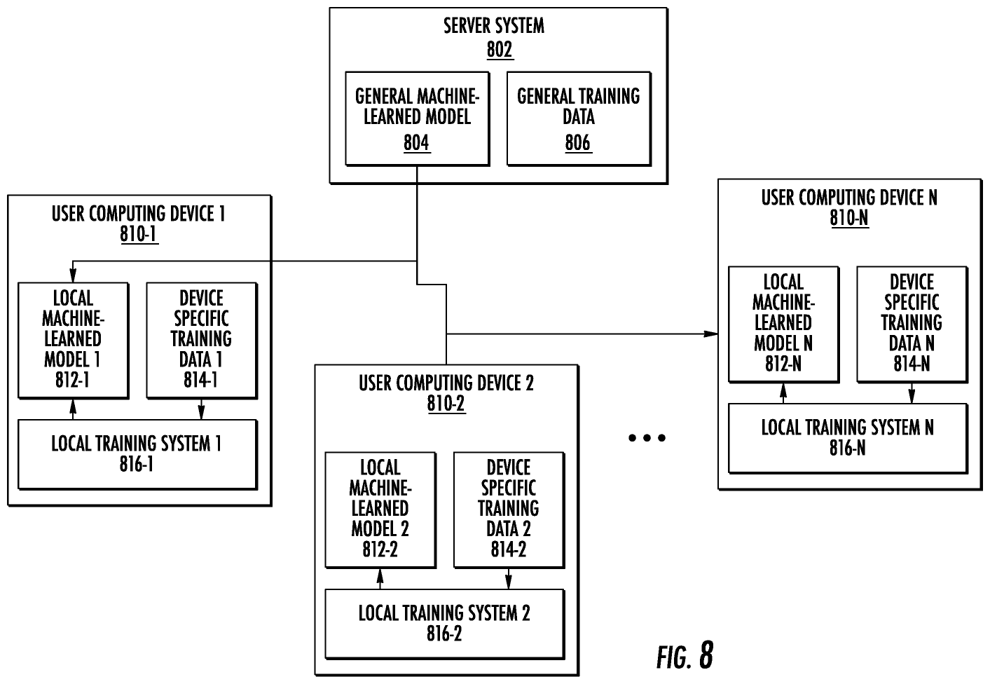

FIG. 8 illustrates an example computing environment including a server system 800 and one or more user computing devices (810-1, 810-2, . . . 810-N) in accordance with example embodiments of the present disclosure. In this example, a server system 802 can store a general machine-learned model 804. The general machine-learned model 804 can be trained using general training data 806. This general machine-learned model 804 can then be distributed to a plurality of user computing devices (e.g., user computing device 1 810-1, user computing device 2 810-2, user computing device N 810-N). In some examples, the general machine-learned model 804 is distributed when the devices are manufactured. In another example, the general machine-learned model 804 can be distributed and or updated via network communications after the devices have been distributed to users.

Each user computing device can include a local version of the machine-learned model (e.g., 812-1, 812-2, or 812-N). The user computing device (810-1, 810-2, or 810-N) can generate device specific training data (e.g., 814-1, 814-2, and 814-N) based on user provided examples of gestures during the training phase and user input data for failed attempts to input a gesture. The device specific training data (e.g., 812-1, 812-2, or 812-N) can be used to train the local machine-learned model (e.g., 812-1, 812-2, or 812-N) by the local training system (e.g., 816-1, 816-2, or 816-N). In this way, the user computer devices have machine-learned models that are customized for their specific users without adjusting the general machine-learned model 804. In addition, if a user owns more than one user computing devices that employ this technology, the two devices can be linked (e.g., via a server system or direct communication between devices) such that the machine-learned models can be standardized between the two devices that have the same user. As a result, updates to the model on a specific computer device can also be made on other devices owned and used by that same user. In some examples, user specific updates to the machine-learned model can be associated with a particular user account and used on any device that the associated user logs into.

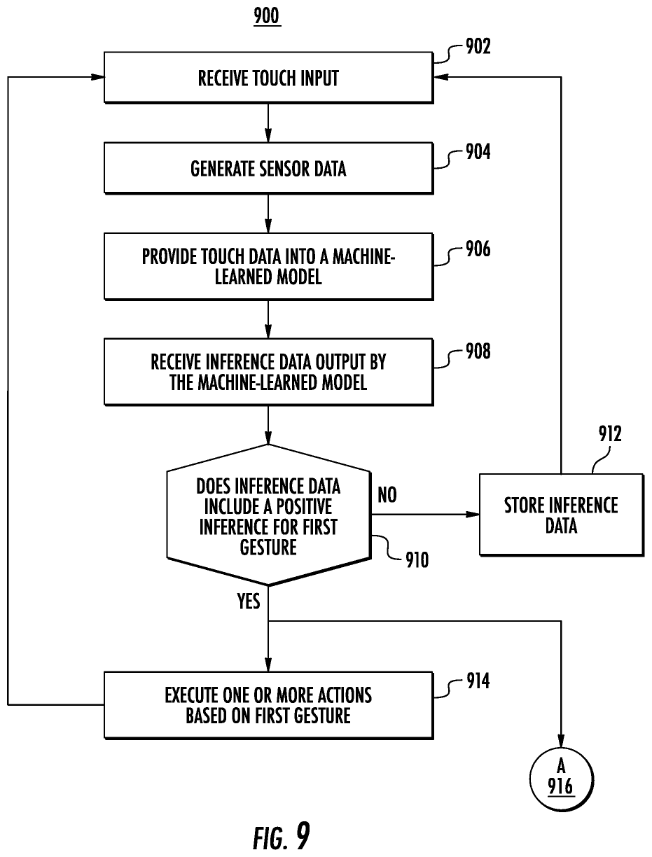

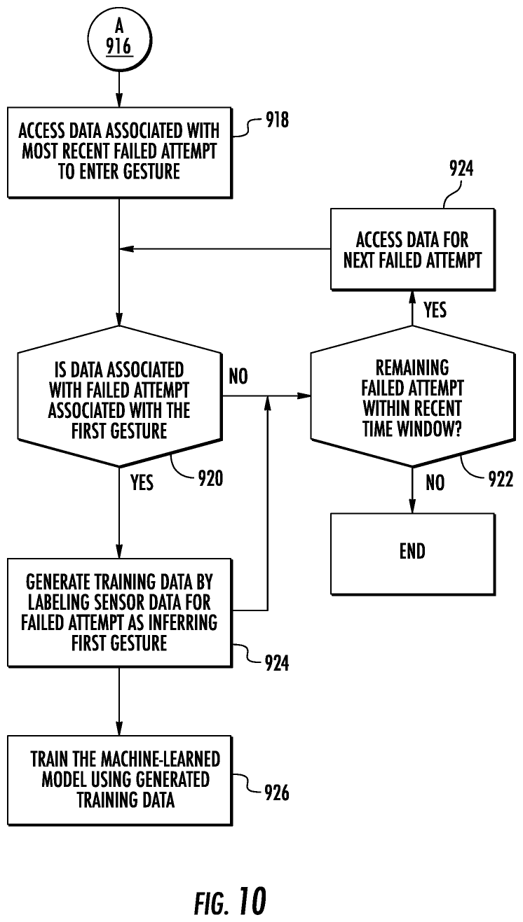

FIG. 9 illustrates an example flow chart 900 for identifying a gesture based on touch input in accordance with example embodiments of the present disclosure. In some examples, an interactive object 200 can receive touch input at 902 using a touch sensor (e.g., touch sensor 214 in FIG. 2) incorporated into the interactive object 200. The touch sensor 214 can generate sensor data at 904 based on the touch input. The sensor data can be provided to a machine-learned model 210 at 906. The machine-learned model 210 can generate inference data based on the sensor data. The interactive object 200 can receive, at 908, inference data from the machine-learned model.

In some examples, the interactive object 200 can determine, at 910, whether the inference data includes a positive inference or a negative inference for the first gesture. If the inference data includes a negative inference for the first gesture (or for all known gestures), the interactive object 200 can store, at 912, inference data associated with the touch input in a failed attempt sensor data storage 234. The stored data can include inference data produced by the machine-learned model and the sensor data generated by the touch sensor 214. The interactive object 200 can receive additional touch input from a user.

In some examples, the interactive object 200 determines that the inference data includes a positive inference for the first gesture, the interactive object 200 can, at 914, execute one or more actions based on the candidate gesture. In addition, the interactive object 200 can analyze the stored failed inputs at 916.

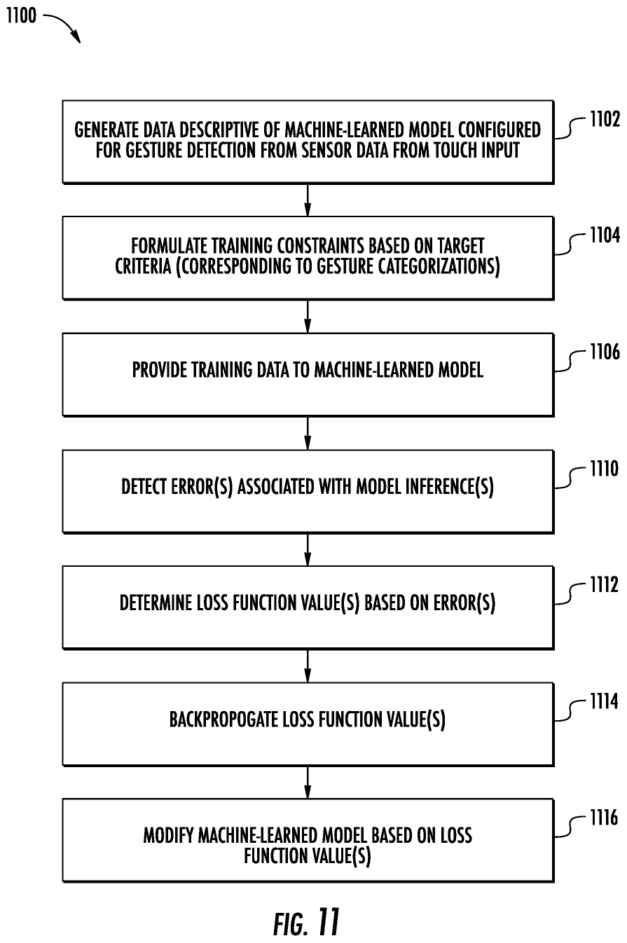

FIG. 10 illustrates an example flow chart for analyzing sensor data associated with failed attempts in accordance with example embodiments of the present disclosure. This figure continues the example from FIG. 9. In this example, the interactive object 200 accesses, at 918, data associated with the most recent failed attempt. The data can include sensor data associated with the most recent failed attempt and inference data generated by the machine-learned model based using touch data from the failed attempt as input.

In some examples, inference data can include one or more candidate gestures associated with the failed attempt. The interactive object 200 can determine, at 920, whether the most recent failed attempt corresponds to the first gesture which was successfully identified by the interactive object 200 based on recently received touch input. For example, the interactive object 200 can determine whether a failed attempt corresponds to the first gesture based on the amount of time that passed between the failed attempt and the successful input of the first gesture. Failed attempts that occur immediately prior to the successful attempts are significantly more likely to correspond to the successful than failed attempts which are further distant in time from the successful attempt.

In some examples, interactive object 200 can determine whether one or more failed attempts correspond to the first gesture based on whether the inference data associated with the most recent failed input has a confidence value for the first gesture above a second confidence value threshold lower than the first confidence value threshold.

If the interactive object 200 determines that the failed attempt does not correspond to the first gesture, the interactive object 200 can determine, at 822, whether any failed inputs are remaining in the failed attempt sensor data storage 234. If no further failed attempts are stored in the failed attempt sensor data storage 234, the interactive object 200 can cease analyzing failed attempts.

In some examples, the interactive object 200 can determine that at least one failed attempt in the failed attempt sensor data storage 234. In this case, the interactive object 200 can access, at 924, data for the next (e.g., the next most recent) failed attempt in the failed attempt sensor data storage 234.

If the interactive object 200 determines that the data associated with the failed input does have a confidence value above the second confidence value threshold, the interactive object 200 can generate, at 924, training data by annotating sensor data for failed sensors as inferring the first gesture. The interactive object 200 can train the machine-learned model using the annotated sensor data at 926.

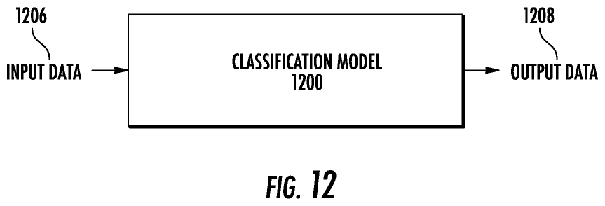

FIG. 11 is a flowchart depicting an example method 1100 of training a machine-learned model that is configured to identify gestures based on sensor data generated in response to touch input from a user. One or more portions of method 1100 can be implemented by one or more computing devices such as, for example, one or more computing devices such as the interactive object 200 as illustrated in FIG. 2. One or more portions of method 1100 can be implemented as an algorithm on the hardware components of the devices described herein to, for example, train a machine-learned model to take sensor data as input, and generate inference data indicative of a gesture corresponding to the sensor data. In example embodiments, method 1100 may be performed by a model trainer using data in training data storage 520 as illustrated in FIG. 5C.

In some examples, data descriptive of a machine-learned model that is configured for gesture detection from sensor data from touch input can be generated at 1102.

One or more training constraints can be formulated at 1102 based on one or more target criteria associated with a particular interactive object and/or a particular computing application. In some examples, training constraints can be formulated based on predefined target criteria for a machine learned continuous embedding space. Any number and/or type of target criteria can be defined and corresponding training constraints formulated for such target criteria.

As a specific example, a product designer for a jacket with an embedded touch sensor can design the system such that one or more actions are associated with particular gestures that can be input by user via touch inputs on the embedded touch sensor. The product designer may establish target criteria for a machine learning embedding space for the gesture recognition functionality. Examples of target criteria may include touch input location, touch input movement, touch input speed, and touch input intensity.

In some examples, training data can be provided to the machine-learned model at 1106. The training data may include sensor data generated in response to example user gestures. In some examples, the training data provides machine learning capabilities to recognize particular gestures based on sensor data generated by a touch sensor in response to user touch input. In some examples, the machine-learned model is trained to output both one or more candidate gestures associated with the sensor data and a confidence value for each candidate gesture, the confidence value representing the likelihood that the sensor data corresponds to a particular gesture. For example, the confidence value can be a value between 0 and 1 with higher values representing increased likelihood that the touch input corresponds to the candidate gesture with which the confidence value is associated. The training data can provide an ‘ideal’ benchmark against which future touch inputs can be measured. When the sensor data for a particular touch input is analyzed, the machine-learned model can match sensor data to gestures, and ultimately be able to generate a list of one or more candidate gestures and assign confidence values for each candidate gesture. In some examples, the training data may include positive training data examples and negative training data examples. In some examples, the positive training data can include examples of the user of a particular device performing touch input that was originally classified as a failed attempt at a gesture. This positive training data can be updated with new positive examples as the user continues to provide touch input to the interactive object.

In some examples, one or more errors associated with the model inferences at 1110. By way of example, an error may be detected in response to the machine-learned model generating an inference that sensor data corresponds to a second gesture in response to training data corresponding to a first gesture. Similarly, an error may be detected in response to the machine-learned model generating a low confidence value that the sensor data corresponds to a first gesture in response to training data that is associated with the first gesture.

In some examples, one or more loss function values can be determined, at 1112, for the machine-learned model based on the detected errors. In some examples, the loss function values can be based on an overall output of the machine-learned model. In other examples, a loss function value can be based on particular output, such as a confidence level associated with one or more candidate gestures. In some examples, a loss function value may include a sub-gradient.

The one or more loss function values can be back propagated, at 1114, to the machine-learned model. For example, a sub-gradient calculated based on the detected errors can be back propagated to the machine-learned model. The one or more portions or parameters of the machine-learned model can be modified, at 1116, based on the backpropagation at 1114.

FIG. 12 depicts a block diagram of an example classification model 1200 according to example embodiments of the present disclosure. A machine-learned classification model 1200 can be trained to receive input data 1206. The input data 1206 can include sensor data generated by a sensor (e.g., touch sensor) in response to touch input by a user. In response to receiving input data 1206, the classification model 1200 can provide output data 1208. The output data can include a gesture determined to correspond to the touch input upon which the input data 120 was generated. In some examples, the output data 1208 can include one or more candidate gestures and confidence values associated with each candidate gesture.

The classification model 1200 can be trained using a variety of training techniques. Specifically, the classification model 1200 can be trained using one of a plurality of unsupervised training techniques or a plurality of supervised training techniques, such as, for example, backward propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over several training iterations. In some implementations, performing backward propagation of errors can include performing truncated backpropagation through time. Generalization techniques (e.g., weight decays, dropouts, etc.) can be performed to improve the generalization capability of the models being trained.

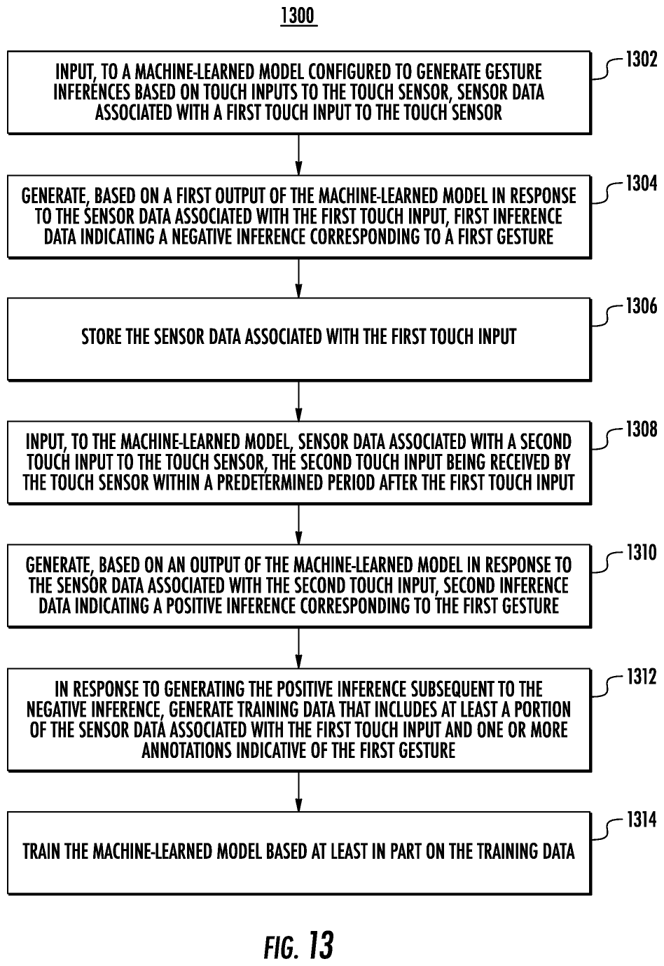

FIG. 13 is a flowchart depicting an example process 1300 of updating a machine-learned model based on the sensor data for failed attempts to input a gesture in accordance with example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1, 2, and 8.

In some examples, an interactive object (e.g., interactive object 200 in FIG. 2) can include a touch sensor (e.g., touch sensor 214 in FIG. 2) configured to generate sensor data in response to touch inputs. The interactive object 200 can further comprise a gesture evaluation system (e.g., gesture evaluation system 212 in FIG. 2). The gesture evaluation system 212 can, at 1302, input, to a machine-learned model (e.g. machine-learned model 210 in FIG. 2) configured to generate gesture inferences based on touch inputs to the touch sensor 214, sensor data associated with a first touch input to the touch sensor 214. For example, a user can provide first touch input to a touch sensor 214. The touch sensor 214 can produce data based on the first touch input (e.g., the touch input causes the touch sensor 214 to produce an electrical signal that can be recorded and analyzed).

The touch sensor 214 can be a capacitive touch sensor or a resistive touch sensor. The touch sensor can be configured to sense single-touch, multi-touch, and/or full-hand touch-input from a user. To enable the detection of touch-input, a touch sensor 214 can include sensing elements. Sensing elements may include various shapes and geometries. In some implementations, the sensing elements do not alter the flexibility of the touch sensor 214, which enables the touch sensor to be easily integrated within textile interactive objects. In some examples, the interactive object and its components are deformable.

The gesture evaluation system 212 can, at 1304, generate, based on a first output of the machine-learned model 210 in response to the sensor data associated with the first touch input, first inference data indicating a negative inference corresponding to a first gesture. The negative inference can indicate non-performance of the first gesture based on the first touch input. Alternatively or additionally, the negative inference can include inference data indicating non-performance of any gesture that the machine-learned model is trained to recognize. In some examples, the machine-learned model 210 comprises a convolutional neural network or a recurrent neural network.

In some examples, determining that the first inference data indicates a negative inference corresponding to the first gesture can include the gesture evaluation system 212 determining that the confidence value associated with the first gesture is below a first confidence value threshold, wherein the first inference data includes a confidence value associated with the first gesture. In response to determining that the confidence value associated with the first gesture is below the first confidence value threshold, the gesture evaluation system 212 can generate a negative inference.

In some examples, if the gesture evaluation system 212 determines that the first inference data indicates a negative inference corresponding to the first gesture, the gesture evaluation system 212 can store, at 1306, the sensor data associated with the first touch input. In some examples, the sensor data associated with the first touch input can be stored in a failed attempt sensor data storage (e.g., see failed attempt sensor data storage 234 in FIG. 2). Additionally, or alternatively, the gesture evaluation system 212 can store also the first inference data in the failed attempt sensor data storage 234 with the sensor data.

The gesture evaluation system 212 can, at 1308, input, to the machine-learned model 210, sensor data associated with a second touch input to the touch sensor 214, the second touch input being received by the touch sensor 214 within a predetermined period after the first touch input. In some examples, the predetermined period is a predetermined period of time immediately prior to the second touch input. For example, the predetermined period can be 30 seconds immediately before the second touch input. Other lengths of time can be used for the predetermined period. In some examples, the predetermined period can be the period since a most recent positive inference was received. In yet other examples, the predetermined period can be the period since a pause in user touch input was detected. For example, if a pause in user input of 10 seconds is detected, the failed attempt sensor data storage 234 can be emptied of touch input from previous failed attempts. However, if the user continuously tries to enter a gesture via touch input without pausing, sensor data for all received touch input can be stored until a successful attempt is recorded or a pause is detected.

The gesture evaluation system 212 can, at 1310, generate, based on an output of the machine-learned model 210 in response to the sensor data associated with the second touch input, second inference data indicating a positive inference corresponding to the first gesture. In response to generating the positive inference subsequent to the negative inference, the gesture evaluation system 212 can, at 1312, generate training data that includes at least a portion of the sensor data associated with the first touch input and one or more annotations that indicate the first touch input as a positive training example of the first gesture.

In some examples, the generated training data can include at least the portion of the sensor data associated with the first touch input. The one or more annotations can indicate the first touch input as a positive training example of the first gesture in response to generating the positive inference subsequent to two or more negative inferences within the predetermined period, the two or more negative inferences comprising the first inference data and at least one additional negative inference. In some examples, the gesture evaluation system 212 generates the training data such that it includes at least the portion of the sensor data associated with the first touch input and the one or more annotations that indicate the first touch input as a positive training example of the first gesture in response to determining by the gesture evaluation system 212 the confidence value associated with associated with the first touch input being above a second confidence value threshold, the second confidence value threshold being less than the first confidence value threshold.

In some examples, the interactive object can include a model update system (e.g., model update system 224 at FIG. 2). The model update system 224 can, at 1314, train the machine-learned model 210 based at least in part on the training data. The machine-learned model 210 can be trained based on a periodic schedule. For example, the local machine-learned model 210 on a user's interactive object can be trained once a day, once an hour, or any other interval that is desired, to reduce power consumption associated with training the machine-learned model. Additionally, or alternatively, the machine-learned model 210 can be trained when new training data is generated.

One or more of the preferred embodiments can often bring about a rich and familiar-feeling user experience with a smart-wearable product, an experience that can be perceived by the user as providing a sense of forgiveness, or forgiving adaptiveness, recognizing that not all physical input gestures by a real human are going to be perfect, by-the-book executions at all times and may have variations depending on the tendencies or disabilities (temporary or permanent) of any particular user. In one example, if the user inputs a first gesture attempt that is an “awkward version” of a gesture (say, an awkward version of the above “circular swipe” gesture on a chest/stomach area sensor of a smart shirt or coat)—because perhaps they are slightly disabled in their arm, or maybe just tired, or maybe their short or coat is not wearing quite right on their body or has a small unintended fold or wrinkle in it—they can be given a normal “rejection” sounding feedback (like a “bounce” sound or “sad trumpet” sound). Like most humans, the user will probably and naturally then make the gesture a second time, this time being a “less awkward” version of the gesture, because the user is putting more effort into it. And if the second attempt is still not good enough, the feedback can again be a “bounce” or “sad trumpet” again to signal a failed gesture. Being human, the user could still very likely try a third attempt, this time with real energy, with real oomph, and this time the circular swipe gesture will more likely get recognized, and the wearable system proceeds accordingly. Meanwhile, according to the one or more embodiments, the wearable system is effectively designed to “remember” the measurement readings for each of the first and second failed attempts and “learn” that this user will have a tendency to give circular-swipes that are not quite “by the book”, and over time, the system will start to recognize “awkward” versions of the gesture from that user as the circular-swipe gesture, thus adapting to that user individually. Advantageously, the entire process feels very natural to the user, being similar in many ways to a typical party-conversation scenario in which a person will say a phrase for a second and third time progressively more loudly, more slowly, and more deliberately if their listener leans in and indicates that they did not quite hear or understand that phrase the first and second times. Subsequently, the listener is usually more able to recognize that phrase the fourth and following times it is said by the person in the conversation, even if not articulated quite as loudly, slowly, and deliberately as when the person said it the second and third times

The technology discussed herein refers to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An interactive object, comprising:
a touch sensor configured to generate sensor data in response to touch inputs; and
one or more computing devices configured to:
input, to a machine-learned model configured to generate gesture inferences based on touch inputs to the touch sensor, sensor data associated with a first touch input to the touch sensor;
generate, based on a first output of the machine-learned model in response to the sensor data associated with the first touch input, first inference data indicating a negative inference corresponding to a first gesture;
store the sensor data associated with the first touch input;
input, to the machine-learned model, sensor data associated with a second touch input to the touch sensor, the second touch input being received by the touch sensor within a predetermined period after the first touch input;
generate, based on an output of the machine-learned model in response to the sensor data associated with the second touch input, second inference data indicating a positive inference corresponding to the first gesture;
in response to generating the positive inference subsequent to the negative inference, generate training data that includes at least a portion of the sensor data associated with the first touch input and one or more annotations that indicate the first touch input as a positive training example of the first gesture; and
train the machine-learned model based at least in part on the training data.

2. The interactive object of claim 1, wherein the negative inference indicates non-performance of the first gesture based on the first touch input.

3. The interactive object of claim 1, wherein the one or more computing devices are configured to generate the training data that includes at least the portion of the sensor data associated with the first touch input and the one or more annotations that indicate the first touch input as a positive training example of the first gesture in response to generating the positive inference subsequent to two or more negative inferences within the predetermined period, the two or more negative inferences comprising the first inference data and at least one additional negative inference.

4. The interactive object of claim 1, wherein the first inference data includes a confidence value associated with the first gesture, and wherein the one or more computing devices are configured to:
determine that the confidence value associated with the first gesture is below a first confidence value threshold;
in response to determining that the confidence value associated with the first gesture is below the first confidence value threshold, generate the negative inference.

5. The interactive object of claim 4, wherein the one or more computing devices are configured to generate the training data that includes at least the portion of the sensor data associated with the first touch input and the one or more annotations that indicate the first touch input as a positive training example of the first gesture further in response to the confidence value associated with the first gesture being above a second confidence value threshold, the second confidence value threshold being less than the first confidence value threshold.

6. The interactive object of claim 1, wherein the negative inference includes inference data indicating non-performance of any gesture that the machine-learned model is trained to recognize.

7. The interactive object of claim 1, wherein the predetermined period is a predetermined period of time immediately prior to the second touch input.

8. The interactive object of claim 1, wherein the predetermined period is a period since a most recent positive inference was received.

9. The interactive object of claim 1, wherein the machine-learned model is trained based on a periodic schedule.

10. The interactive object of claim 1, wherein the sensor is a capacitive touch sensor.

11. The interactive object of claim 1, wherein the interactive object is deformable.

12. The interactive object of claim 1, wherein the machine-learned model comprises a convolutional neural network or a recurrent neural network.

13. A computing device, comprising:
an input sensor configured to generate sensor data in response to a user gesture input;
one or more processors configured to:
input, to a machine-learned model configured to generate gesture inferences based on user gesture inputs to the input sensor, sensor data associated with a first user input to the input sensor;
generate, based on a first output of the machine-learned model in response to the sensor data associated with the first user input, first inference data indicating a negative inference corresponding to a first gesture;
store the sensor data associated with the first user input;
input, to the machine-learned model, sensor data associated with a second user input to the input sensor, the second user input being received by the input sensor within a predetermined period after the first user input;
generate, based on an output of the machine-learned model in response to the sensor data associated with the second user input, second inference data indicating a positive inference corresponding to the first gesture;
in response to generating the positive inference subsequent to the negative inference, generate training data that includes at least a portion of the sensor data associated with the first user input and one or more annotations that indicate the first user input as a positive training example of the first gesture; and
train the machine-learned model based at least in part on the training data.

14. The computing device of claim 13, wherein the input sensor comprises a RADAR sensor and wherein the first user input and the second user input comprise a first touch-free gesture input and a second touch-free gesture input.

15. The computing device of claim 13, wherein the input sensor comprises a touch sensor and wherein the first user input and the second user input comprise a first touch input and a second touch input.

16. The computing device of claim 13, wherein the one or more computing devices are configured to generate the training data that includes at least the portion of the sensor data associated with the first user input and the one or more annotations that indicate the first user input as a positive training example of the first gesture in response to generating the positive inference subsequent to two or more negative inferences within the predetermined period, the two or more negative inferences comprising the first inference data and at least one additional negative inference.

17. The computing device of claim 13, wherein the first inference data includes a confidence value associated with the first gesture, and wherein the one or more computing devices are configured to:
determine that the confidence value associated with the first gesture is below a first confidence value threshold;
in response to determining that the confidence value associated with the first gesture is below the first confidence value threshold, generate the negative inference.

18. The computing device of claim 17, wherein the one or more computing devices are configured to generate the training data that includes at least the portion of the sensor data associated with the first user input and the one or more annotations that indicate the first user input as a positive training example of the first gesture further in response to the confidence value associated with the first gesture being above a second confidence value threshold, the second confidence value threshold being less that the first confidence value threshold.

19. A computer-implemented method, the method performed by a computing system comprising one or more computing devices, the method comprising:
inputting, to a machine-learned model configured to generate gesture inferences based on touch inputs to a touch sensor, sensor data associated with a first touch input to the touch sensor;
generating, based on a first output of the machine-learned model in response to the sensor data associated with the first touch input, first inference data indicating a negative inference corresponding to a first gesture;
storing the sensor data associated with the first touch input;
inputting, to the machine-learned model, sensor data associated with a second touch input to the touch sensor, the second touch input being received by the touch sensor within a predetermined period after the first touch input;
generating, based on an output of the machine-learned model in response to the sensor data associated with the second touch input, second inference data indicating a positive inference corresponding to the first gesture;
in response to generating the positive inference subsequent to the negative inference, generating training data that includes at least a portion of the sensor data associated with the first touch input and one or more annotations that indicate the first touch input as a positive training example of the first gesture.

20. The computer-implemented method of claim 19, further comprising:
training the machine-learned model based at least in part on the training data.
